(19) United States
(12) Patent Application Publication
(10) Pub. No.: US 2011/0160014 A1
(43) Pub. Date: Jun. 30, 2011

(54) BELT TRANSMISSION SYSTEM AND BELT USED IN THE SYSTEM

(75) Inventor: Hideaki Kawahara, Hyogo (JP)

(73) Assignee: BANDO CHEMICAL INDUSTRIES, LTD., Hyogo (JP)

(21) Appl. No.: 13/061,374

(22) PCT Filed: Aug. 26, 2009
(86) PCT No.: PCT/JP2009/004120

§ 371 Date: Feb. 28, 2011

(30) Foreign Application Priority Data
Aug. 29, 2008 (JP) 2008-221032

(51) Int. Cl. F16H 7/02; F16G 1/10

(52) U.S. Cl. 474/148

(57) ABSTRACT

In a belt transmission system A, a drive pulley 1 and at least one driven pulley 2-4 are flat pulleys, and power transmission between the pulleys is performed through a substantially flat transmission surface b1 of the power transmission belt B. This can improve transmission efficiency and durability of the power transmission belt to be comparable to those of a flat belt, while significantly reducing the cost of the system. A plurality of protrusions 82a extending in the longitudinal direction of the belt are provided on an outer surface of the belt, and are allowed to engage with circumferential grooves 5a of a restriction pulley 5, 6, thereby restricting movement of the power transmission belt in the lateral direction of the belt. This can keep the belt running stably even when rainwater etc. is adhered to the belt or the pulley.

### TECHNICAL FIELD

The present invention relates to a technology of friction transmission by a belt, particularly to measures to prevent snaking of a belt having a flat transmission surface.

### BACKGROUND ART

V belts and V-ribbed belts have widely been used as friction power transmission belts. In particular, the V-ribbed belts can provide a wedge effect like the V belts, and have relatively high flexibility, and low bending loss. Accordingly, the V-ribbed belts are suitable for belt transmission systems, e.g., accessory drives of automobiles, which are required to be compact, and to have high transmission efficiency irrespective of their high rotation speed, and great rotation changes.

In conventional belt transmission systems using the V-ribbed belt, ribbed pulleys constitute not only a drive pulley, but also most of driven pulleys. The ribbed pulleys require high processing precision, and increased number of processes, thereby increasing the cost.

The V-ribbed belt experiences great loss induced by bending as compared with a flat belt, and great loss induced by friction when the ribs of the V-ribbed belt are rubbed against the ribs of the ribbed pulley when the V-ribbed belt comes onto or separates from the ribbed pulley. Further, since the V-ribbed belt is wrapped around the pulley with a thick ribbed rubber layer in contact with the pulley, great loss induced by shear deformation of the ribbed rubber layer. Therefore, the V-ribbed belt is reduced in transmission efficiency as compared with the flat belt, and may possibly experience degradation of rubber due to heat generation.

When the ribbed rubber layer is deformed to provide the wedge effect, the rubber layer in which cords are embedded may be deformed to become corrugated in a lateral direction of the belt. This may bring about various disadvantages, such as separation of the cords etc. Further, due to the wedge effect, the belt is less likely to slip even when great impact is applied thereto. This may lead to break of the belt.

When the ribs of the V-ribbed belt are rubbed against the ribs of the ribbed pulley as described above, noise may be generated, and belt life tends to be reduced due to wear. Such disadvantages become worse as a result of misalignment, such as displacement, warpage, etc. of a shaft of the pulley.

The flat belt does not have the above-described disadvantages associated with the V-ribbed belt. However, the flat belt may disadvantageously cause snaking, or may be off-centered relative to the pulley due to the misalignment etc.

As a known solution to the snaking and the offset of the flat belt, a crown is provided on an outer circumferential surface of the flat pulley (see, e.g., Patent Document 1), or flanges are provided on lateral ends of the pulley. However, such measures are not sufficient to prevent the snaking and the offset of the belt, and are less practical because a load is concentrated on a certain part of the belt. For these reasons, the flat belt has not been practically used in the transmission systems.

To solve the snaking etc. of the flat belt, the applicant of the present application has focused on the fact that the position of a load applied to the shaft of the pulley changes depending on tension of the belt when the belt is off-centered. Based on the finding, the applicant has proposed a novel mechanism (an anti-snaking pulley), wherein the pulley which received the load shakes to become diagonally opposite to the belt, thereby canceling the offset of the belt (see, e.g., Patent Document 2).

### CITATION LIST

### Patent Documents

[Patent Document 1] Japanese Utility Model Publication No. S59-45351
[Patent Document 2] Japanese Patent Publication No. 2006-10072

### SUMMARY OF THE INVENTION

### Technical Problem

As described above, the belt transmission system using the V-ribbed belt is still disadvantageous in terms of cost and durability as compared with the belt transmission system using the flat belt, and is susceptible to improvement in terms of efficiency. However, the belt transmission system using the flat belt has a disadvantage of snaking, and has not been practically used.

In view of the disadvantages of the flat belt, such as snaking etc., the anti-snaking pulley according to the above-described proposal (Patent Document 2) involves in increase in cost by employing the anti-snaking pulley. Further, the anti-snaking function may be reduced when rainwater, mud, or dust is adhered to the anti-snaking pulley depending on the service condition.

An object of the present invention is to provide a transmission system at relatively low cost, in which the transmission efficiency and the durability are improved to be comparable to systems using the flat belt, and the belt can be kept running stably even when rainwater etc. is adhered thereto.

### Solution to the Problem

To achieve the object, according to the present invention, power is transmitted through a substantially flat transmission surface of the belt to reduce the cost of the belt transmission system including the pulleys. Further, a plurality of protrusions extending in a longitudinal direction of the belt are provided on an outer surface of the belt to restrict movement of the belt in the lateral direction of the belt, while keeping the transmission efficiency and the durability to be comparable to those of the flat belt.

Specifically, the invention recited in claim 1 of the present application is directed to a belt transmission system including: an endless power transmission belt which is wrapped around a drive pulley, and at least one driven pulley, wherein the power transmission belt includes cords which are embedded in the power transmission belt to extend in a longitudinal direction of the belt, and to be aligned in a lateral direction of the belt, an inner surface inside the cords constituting a substantially flat transmission surface, a plurality of protrusions which are formed on an outer surface of the power transmission belt to extend in the longitudinal direction of the belt, and to be aligned in the lateral direction of the belt.

The power transmission belt is wrapped around the drive pulley, and the at least one driven pulley with the inner surface in contact with the pulleys, and a restriction pulley having a plurality of circumferential grooves formed in an outer circumferential surface thereof is pressed onto the outer surface of the power transmission belt to engage with the protrusions, thereby restricting movement of the power transmission belt in the lateral direction of the belt.

In the above-described belt transmission system, the drive pulley and the at least one driven pulley are flat pulleys, which do not require high processing precision and increased number of processes. This can significantly reduce the cost as compared with the belt transmission system using the conventional V-ribbed belt. Further, the belt is wrapped around the flat pulleys with the substantially flat transmission surface of the belt in contact with the flat pulleys, and the cords are provided very close to the transmission surface. Accordingly, losses induced by bending and friction are as low as those of the flat belt are, and the rubber layer is prevented from excessive shear deformation. Thus, the transmission efficiency is increased, and the heat generation is reduced to be comparable to the systems using the flat belt.

In particular, since a relatively large load is applied to the drive pulley, use of the flat pulley as the drive pulley is significantly advantageous. Specifically, the larger load the pulley has, the more the rubber layer of the belt becomes deformed when the belt is wrapped around the pulley, thereby increasing the loss and the heat generation.

In the above-described configuration, the transmission surface of the belt is substantially flat, and does not provide the wedge effect. Accordingly, the heat generation would not be increased due to the wedge effect. Further, even when a large load is applied, the rubber layer around the cords would not be deformed to become corrugated, and a large load is not applied to the rubber layer. This is advantageous for improving the durability of the belt. Even when great impact is applied, the transmission surface can suitably slip. This is also advantageous for improving the durability of the belt.

With the above-described configuration, the circumferential grooves of the restriction pulley engage with the plurality of protrusions formed on the outer surface of the power transmission belt. This can stably and reliably restrict the movement of the power transmission belt in the lateral direction of the belt, thereby preventing the snaking and the offset of the power transmission belt even when rainwater, dust, etc. is adhered to the pulley or the belt. When the snaking and the offset of the belt are restricted by the plurality of protrusions, a load would not be concentrated on a certain part of the belt. The number of the protrusions is preferably 3 or more.

The restriction pulley does not have to function as a transmission pulley. Therefore, for example, the restriction pulley is preferably used under a load as small as possible, like the idler pulley. However, the restriction pulley can also be used as one of a plurality of driven pulleys to which a relatively small load is applied (claim 2). The restriction pulley can be used as a tension pulley. In summary, taking the general layout of the belt into account, the minimum required number of restriction pulleys (i.e., at least one) is provided at a position where the snaking can effectively be prevented.

Each of the protrusions of the power transmission belt has a trapezoidal cross section in which side surfaces of the protrusion inclined to approach each other toward a distal end thereof, and each of the circumferential grooves of the restriction pulley in which the corresponding protrusion enters has side surfaces which are inclined to move away from each other from a bottom to an opening end thereof (claim 3). With this configuration, the protrusions of the belt can smoothly slide into the circumferential grooves of the restriction pulley without greatly rubbing the circumferential grooves. This can reduce the loss induced by the friction, and the wear, and can advantageously reduce the occurrence of noise.

When the circumferential grooves of the restriction pulley are shaped to correspond with the shape of the protrusions of the power transmission belt, the wedge effect may be provided. Since the restriction pulley does not transmit the power, the adverse effect by the wedge effect, if any, is relatively small. To restrict the movement of the belt in the lateral direction of the belt, the wedge effect is unnecessary, and may reduce the transmission efficiency and the durability as described above. Therefore, the shape of the protrusions of the belt, the shape of the circumferential grooves of the pulley, and their positional relationship are preferably determined in such a manner that the wedge effect is not provided, or is significantly reduced.

Specifically, a correlation between the height and the pitch of the protrusions of the power transmission belt, and the depth and pitch of the circumferential grooves of the restriction pulley, or the degree of inclination of their side surfaces are adjusted, for example, in such a manner that an end surface at a distal end of each of the protrusions is in contact with a bottom surface of the circumferential groove, the wedge effect can easily be reduced (claim 4). The end surface of each of the protrusions is preferably a flat surface, but is not limited thereto. The end surface may have any shape corresponding to the shape of the groove bottom surface of the pulley.

In this case, a sum of dimensions of the end surfaces of the protrusions in the lateral direction of the belt is preferably half or more of a dimension of the power transmission belt in the lateral direction of the belt (claim 5). With this configuration, the end surfaces of the protrusions occupy half or more of the area of the outer surface of the belt. This is advantageous for providing the above-described advantages. Further, the outer circumferential surface of the restriction pulley except for the circumferential grooves may be in contact with part of the power transmission belt between adjacent protrusions (claim 6).

Seeing from a different angle, the present invention is directed to a power transmission belt used in the above-described transmission system. The power transmission belt includes: an inner surface of an endless belt body constituting a substantially flat transmission surface, the power transmission belt being wrapped around a drive pulley, and at least one driven pulley for power transmission, wherein cords are embedded in the belt body to extend in a longitudinal direction of the belt, and to be aligned in a lateral direction of the belt, and a plurality of protrusions are formed on an outer surface of the belt outside the cords to extend in the longitudinal direction of the belt, and to be aligned in the lateral direction of the belt in such a manner that the protrusions engage with a restriction member for restricting movement of the belt in the lateral direction of the belt (claim 7).

The power transmission belt is wrapped around the flat drive pulley and the at least one flat driven pulley with the inner surface (the substantially flat transmission surface) in contact with the pulleys, and the restriction member, such as the above-described restriction pulley, is pressed onto the outer surface of the power transmission belt, thereby allowing the protrusions of the belt to engage with the circumferential grooves. Accordingly, the belt transmission system of claim 1 described above is provided, and the advantages are obtained. The member for restricting the movement of the belt in the lateral direction of the belt may be a member except for the above-described restriction pulley.

As described above, each of the protrusions of the power transmission belt preferably has a trapezoidal cross section in which side surfaces of the protrusion are inclined to approach each other toward a distal end thereof (claim 8).

As described above, each of the protrusions has an abutment surface which is provided at the distal end thereof, and is in contact with a bottom surface of the circumferential groove (claim 9). Alternatively, an abutment portion may be provided between adjacent protrusions to be in contact with the outer circumferential surface of the pulley except for the circumferential grooves (claim 10).

### Advantages of the Invention

According to the belt transmission system of the present invention described above, the power transmission from the drive pulley to the driven pulley is performed mainly through the substantially flat transmission surface on the inner surface of the power transmission belt. This can significantly reduce the cost of the belt transmission system including the pulleys, and can improve the transmission efficiency and the durability of the belt transmission system to be comparable to the belt transmission systems using the flat belt. Further, a plurality of protrusions are provided on the outer surface of the belt to extend in the longitudinal direction of the belt, and the movement of the belt in the lateral direction of the belt is restricted by the protrusions. This can stably and reliably prevent the snaking etc. of the belt even when rainwater etc. is adhered to the belt or the pulley.

### BRIEF DESCRIPTION OF THE DRAWINGS

FIG. 1 is a schematic view illustrating the structure of a belt transmission system of the present invention applied to an accessory drive of an engine.

FIG. 2 is a partial cross-sectional view illustrating a relationship between protrusions of a power transmission belt, and circumferential grooves of a restriction pulley.

FIG. 3 is a cross-sectional view illustrating the belt and the pulley in an engaged state.

FIG. 4 illustrates an example of a layout of a tester for checking transmission capability of the belt.

FIG. 5 shows a graph illustrating a relationship between a slip ratio of the belt and a load torque.

FIG. 6 shows a graph illustrating a relationship between transmission efficiency of the belt and a load torque.

FIG. 7 is a view corresponding to FIG. 4 illustrating a layout of pulleys for a heat resistance durability test.

FIG. 8 is a view corresponding to FIG. 4 illustrating a layout of pulleys for a multi-axis bending test.

### DESCRIPTION OF EMBODIMENTS

An embodiment of the present invention will be described in detail below with reference to the drawings. The following embodiment is set forth merely for the purposes of preferred examples in nature, and is not intended to limit the scope, applications, and use of the invention.

### (Belt Transmission System)

FIG. 1 schematically shows a layout of a belt and pulleys as an example of a belt transmission system A of the present invention applied to an accessory drive of an engine. In FIG. 1, reference character 1 indicates a crank pulley, which is a drive pulley fixed to a crank shaft (not shown) of an engine E to be rotatable together with the crank shaft, and reference characters 2-4 indicate driven pulleys attached to accessories of the engine E. For example, reference character 2 indicates a PS pump pulley fixed to a rotation shaft of a power steering pump (not shown), which is one of engine accessories, to be rotatable together with the rotation shaft. Reference character 3 indicates an alternator pulley fixed to a rotation axis of an alternator (not shown). Reference character 4 indicates a compressor pulley fixed to a rotation axis of an air-conditioning compressor (not shown).

Reference character 5 in FIG. 1 indicates a tension pulley of an auto tensioner 7 for adjusting tension of a power transmission belt B, and reference character 6 indicates an idler pulley. The structure of the belt transmission system A shown in FIG. 1 is merely illustrated as an example. The belt transmission system of the present invention is applicable to various types of industrial machines, and other devices, and the layout of the belt may be changed depending on the requirements of the devices, etc.

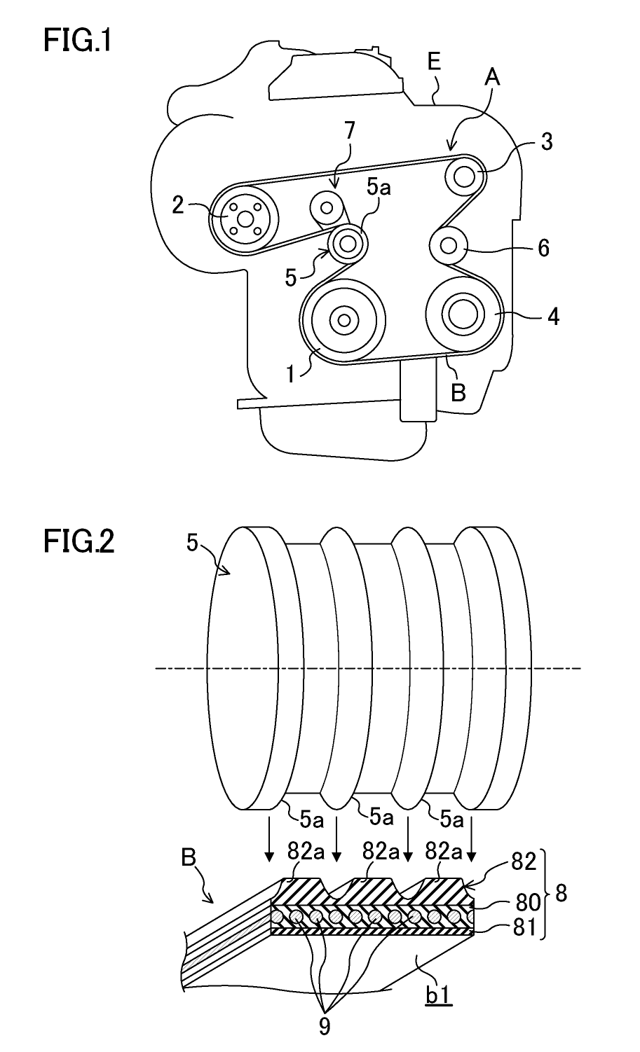

The crank pulley 1, the PS pump pulley 2, the alternator pulley 3, and the compressor pulley 4 are flat pulleys. A plurality of circumferential grooves 5a are formed in outer circumferential surfaces of the tension pulley 5 and the idler pulley 6 (FIG. 2 shows only the circumferential grooves 5a formed in the tension pulley 5). The endless power transmission belt B is wrapped around the pulleys 1-6. As the crank shaft (the crank pulley 1) rotates according to the operation of the engine E, the belt B runs in the clockwise direction from the crank pulley 1, the tension pulley 5, the PS pump pulley 2, the alternator pulley 3, the idler pulley 6, the compressor pulley 4, and the crank pulley 1, thereby driving the accessories.

Specifically, the power transmission belt B is wrapped around the crank pulley 1 and the accessory pulleys 2-4 with a substantially flat inner transmission surface b1 pressed onto outer circumferential surfaces of the flat pulleys 1-4, and is wrapped around the tension pulley 5 and the idler pulley 6 with an outer surface (a back surface) pressed onto the pulleys 5 and 6. That is, the power transmission belt B is wrapped around the pulleys in a so-called serpentine layout.

In short, the belt transmission system A of the present invention allows power transmission between the flat crank pulley 1 and the accessory pulleys 2-4 through the substantially flat transmission surface b1 of the power transmission belt B, with a plurality of protrusions 82a formed on the outer surface of the belt (see FIG. 2) engaged with the circumferential grooves 5a formed in the outer circumferential surfaces of the pulleys 5 and 6, thereby restricting the movement of the belt in the lateral direction of the belt. Thus, in the following specification, the tension pulley 5 and the idler pulley 6 may be referred to as restriction pulleys.

### (Power Transmission Belt and Restriction Pulley)

As specifically shown in FIG. 2, a belt body 8 of the power transmission belt B includes an adhesive rubber layer 80 in which cords 9 made of aramid or polyester are embedded as a tension member, a relatively thin inner rubber layer 81 formed on an inner surface of the adhesive rubber layer 80, and a relatively thick outer rubber layer 82 formed on an outer surface of the adhesive rubber layer 80.

In the illustrated example, the adhesive rubber layer 80 has a thickness of about 0.8-1.2 mm, and the cords 9 are embedded in the adhesive rubber layer 80 to extend in the longitudinal direction of the belt, and to be aligned in the lateral direction of the belt. The cords 9 have a diameter of about 0.7-1.0 mm, and are arranged at a pitch of about 0.8-1.2 mm, for example. The adhesive rubber layer 80 is made of a hard rubber composition mixed with short aramid-based fiber to prevent the adhesive rubber layer 80 from separating from the cords 9.

The inner rubber layer 81 is a rubber layer which is provided with the transmission surface b1, and constitutes an inner surface of the belt. In the illustrated example, for example, the inner rubber layer 81 has a thickness of about 0.4-0.6 mm, and is made of a rubber composition containing ethylene-α-olefin elastomer as a main ingredient, such as EPDM. When a hydrophilic material such as silica is contained in the inner rubber layer 81, reduction in transmission capability in the presence of water can be reduced.

The outer rubber layer 82 constituting the outer surface of the belt is provided with a plurality of protrusions 82a (three in the illustrated example) which extend in the longitudinal direction of the belt, and are aligned in the lateral direction of the belt. Each of the protrusions 82a has a trapezoidal cross section, and has a flat surface formed at a distal end thereof to be in contact with a bottom surface of the circumferential groove 5a formed in the restriction pulley 5, 6 as described below. Side surfaces of each of the trapezoidal protrusions are inclined in such a manner that a width of the protrusion is gradually decreased toward the distal end, and a valley which is substantially V-shaped when viewed in cross section is formed between adjacent protrusions 82a. In the illustrated example, a distance (pitch) between the adjacent protrusions 82a is about 3.5-3.6 mm.

Like the inner rubber layer 81 described above, the outer rubber layer 82 is made of a rubber composition containing ethylene-α-olefin elastomer rubber as a main ingredient. However, different from the inner rubber layer 81, the outer rubber layer 82 does not contribute to the power transmission. Accordingly, short fiber may be mixed in the outer rubber layer 82 to reduce a coefficient of friction between the outer rubber layer 82 and the circumferential grooves 5a of the restriction pulley 5, 6. With this configuration, noise which is made by the belt coming onto and separating from the restriction pulley 5, 6 as described below can be reduced. Further, reinforcing fabric may be adhered to the outer rubber layer 82 to reduce the friction coefficient, which can improve resistance to wear.

The restriction pulley 5, 6 is pressed onto the outer surface of the power transmission belt B provided with the protrusions 82a to prevent snaking of the belt. In the example shown in FIG. 2, the protrusions 82a engage with the circumferential grooves 5a formed in the whole circumferential surface of the tension pulley 5, respectively. The engagement of the protrusions and the circumferential grooves 5a of the tension pulley 5 will be described below, but the same is applied to the engagement of the protrusions and the circumferential grooves of the idler pulley 6.

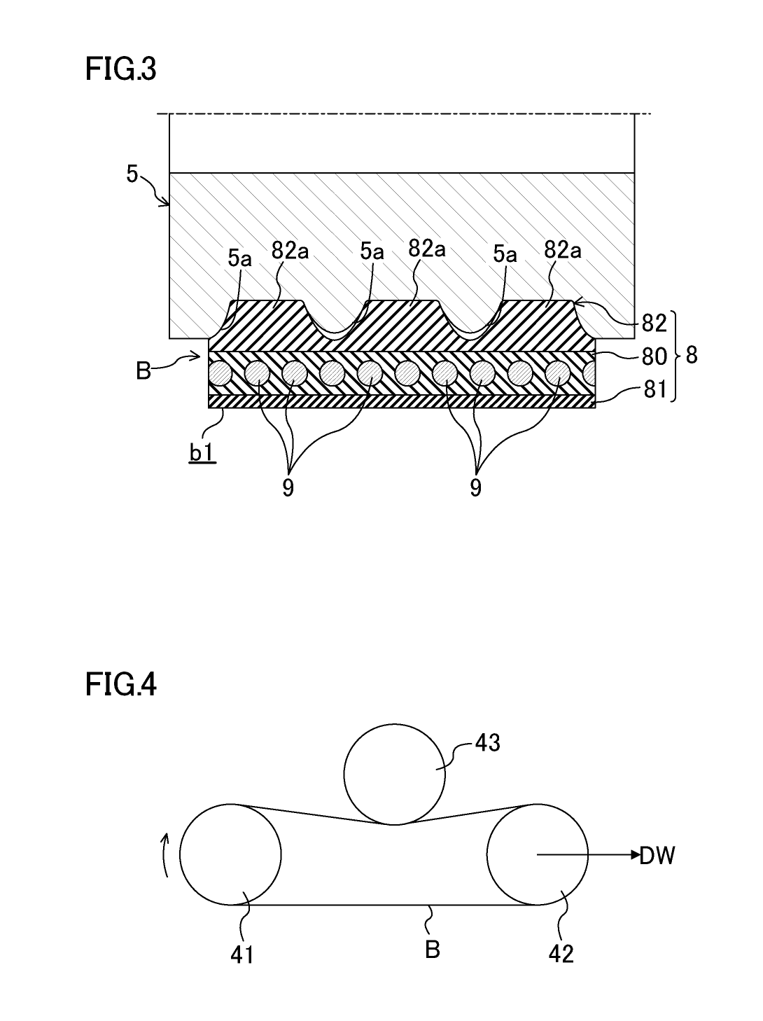

As shown in FIGS. 2 and 3, each of the circumferential grooves 5a of the restriction pulley 5 has a trapezoidal cross section including a flat groove bottom, and side surfaces which are inclined to approach each other toward the flat groove bottom to correspond with the shape of the protrusion 82 of the belt B which engages with the circumferential groove. Specifically, each of the protrusions 82a is gradually narrowed toward the distal end, while each of the circumferential grooves 5a is gradually widened toward an opening end thereof. Thus, when they engage with each other, significant friction is less likely to occur, and therefore, the noise is less likely to occur. If the belt B is greatly misaligned with the pulley, the protrusions 82a can smoothly slide into the grooves 5a.

In the present embodiment, a correlation between the height and pitch of the protrusions 82a, and the depth and pitch of the circumferential grooves 5a, or the angles of their side surfaces etc. are determined in such a manner that the flat surfaces at the distal ends of the protrusions 82a (upper ends in the figure) abut the groove bottoms of the circumferential grooves 5a when the protrusions 82a engage with the circumferential grooves 5a as shown in FIG. 3. Therefore, unlike the general V-ribbed belt, the protrusions 82a which entered the circumferential grooves 5a as shown in FIG. 3 hardly provide the wedge effect, and adverse effects derived from the wedge effect, such as reduction in transmission efficiency and durability, can be resolved in most cases.

Particularly in the illustrated example, a sum of lateral dimensions of the end surfaces of the three protrusions 82a is half or more of a lateral dimension of the belt. This indicates that the end surfaces of the protrusions occupy half or more of an area of the power transmission belt B. A load between the belt B and the pulley 5, 6 is supported by the end surfaces, thereby sufficiently reducing the wedge effect. In this example, the circumferential grooves 5a of the restriction pulley 5 are arranged at a pitch of 3.55-3.65 mm, for example, which is slightly larger than the pitch of the protrusions 82a of the power transmission belt B. Therefore, even if the belt B is inclined relative to the pulley due to misalignment, noise caused by the rubbing of the belt and the pulley is less likely to occur.

The restriction pulleys 5 and 6 described above can be manufactured at low cost, for example, by injection molding using a thermoplastic resin. In this case, mechanical strength of the restriction pulleys 5 and 6 cannot be very high, but this is not disadvantageous because the restriction pulleys 5 and 6 do not contribute to the power transmission. For example, polyamide, which is an inexpensive and versatile, can suitably be used as the resin, and glass fiber may be mixed in the resin to increase the strength.

Although a resin having a higher strength may be used to manufacture the flat crank pulley 1 and the flat accessory pulleys 2-4, use of an iron sheet can reduce the cost. A crown may or may not be provided on the outer circumferential surface of the pulley. When the crown is provided, the transmission capability can slightly be increased, and an anti-snaking function of the crown can be expected. This can reduce the number of the restriction pulleys, and is advantageous for cost reduction. In this example, the tension pulley 5 or the idler pulley 6 may be a flat pulley.

### (Advantages)

Thus, according to the belt transmission system A of the present embodiment described above, contrary to the transmission systems using the general V-ribbed belt, all the crank pulley 1 and the accessory pulleys 2-4 are flat pulleys, and the power transmission is performed through the substantially flat transmission surface b1 of the power transmission belt B. Thus, loss induced by bending of the belt B, loss induced by friction between the belt and the pulley, and loss induced by shear deformation of the rubber layer are reduced to be comparable as those of the system using the flat belt, thereby increasing transmission efficiency, and durability.

Specifically, since the general conventional V-ribbed belt includes a thick ribbed rubber layer, the loss induced by bending is high as compared with the flat belt. The ribbed rubber layer is compressed between the cords and the outer circumferential surface of the ribbed pulley, and experiences significant shear deformation, thereby causing great loss, and reducing the transmission efficiency as compared with the flat belt. The significant deformation of the ribbed rubber layer increases the amount of generated heat, thereby accelerating the degradation of the rubber.

Since each of the V-shaped ribs provides the wedge effect, the belt is deformed in such a manner that the entire part of the belt sinks into the pulley, thereby inducing significant chronologic reduction in tension. In view of this phenomenon, the initial tension has to be set higher. This also leads to increase in mechanical loss, accelerates the heat generation described above, and induces significant wear of the belt or a pulley bearing.

When each of the V-shaped ribs provides the wedge effect, the adhesive rubber layer with the cord embedded therein is deformed to become corrugated in the lateral direction of the belt, and a great shear stress is generated between the cords and the rubber surrounding the cords, thereby inducing separation of the rubber layer from the cords. The wedge effect which allows the belt to be less likely to slip even when great impact is applied to the belt may result in break of the belt.

In the present embodiment, different from the general V-ribbed belt, the substantially flat transmission surface b1 of the belt B is wrapped around the crank pulley 1 and the accessory pulleys 2-4 to which a large load is applied, and the thin inner rubber layer 81 near the cords 9 is substantially uniformly deformed. Thus, loss induced by bending, friction, or shear deformation is not very high. Since the outer rubber layer 82 does not provide the wedge effect, the amount of generated heat is not increased, and a great load is not applied to the adhesive rubber layer 80 surrounding the cords 9, unlike the V-ribbed belt. When great impact is applied, the transmission surface b1 can suitably slip. Therefore, the durability of the power transmission belt B can significantly be improved.

With the transmission efficiency and the durability improved to be comparable to those of the system using the flat belt, the belt transmission system A of the present embodiment is suitably applied to systems in which relatively high tension and load are applied to the belt. Even when the great load is applied, the belt of the present embodiment can be reduced in width as compared with the V-ribbed belt, thereby reducing the size of the system, and significantly contributing to cost reduction of the system including the pulleys. As described in the present embodiment, use of the tension pulley 5 and the idler pulley 6 as restriction pulleys which restrict the snaking of the belt B can advantageously reduce the size of the system.

The crank pulley 1 and the accessory pulleys 2-4, which contribute to the power transmission, and are required to be mechanically strong, are flat pulleys. Therefore, unlike the ribbed pulleys, there is no need to process the flat pulleys with high precision. For example, the flat pulleys may be made of sheet metal, thereby reducing the cost to a further degree. The tension pulley 5 and the idler pulley 6 which are ribbed pulleys do not have to be processed with high precision, and do not have to have high strength because they do not contribute to the power transmission. Therefore, the tension pulley 5 and the idler pulley 6 can be manufactured at low cost, for example, by injection molding of a resin.

In the present embodiment, the restriction pulley 5, 6 is pressed onto the outer surface of the power transmission belt B on which the plurality of protrusions 82a are formed. This can restrict the lateral movement of the power transmission belt B, thereby stably and reliably preventing the snaking and the offset of the belt. If rainwater, dust, etc. is adhered to the belt or the pulley, the belt or the pulley is not significantly affected. Since the plurality of protrusions 82a engage with the circumferential grooves 5a of the pulley 5, 6, respectively, the load is not concentrated on a certain part of the belt B.

Since the protrusions 82a engage with the circumferential grooves 5a, part of the outer rubber layer 82 of the power transmission belt B wrapped around the restriction pulley 5, 6 may cause the wedge effect. However, since these pulleys 5 and 6 hardly have a rotational load, the belt does not experience significant shear deformation. Even if the wedge effect is provided, the adverse affect by the wedge effect is small. Further, in the present embodiment, the end surfaces of the protrusions 82a are brought into contact with the bottoms of the circumferential grooves 5a so as not to provide the wedge effect. Thus, the wedge effect does not substantially have the adverse effect.

### EXAMPLES

Tests for evaluating the capabilities of the belt transmission system A of the present invention will be described below. A power transmission belt of Example was the same as the belt shown in FIG. 2, and had a length of 1120 mm, a width of 10.7 mm, and a thickness of 3.2 mm (including the protrusions). Three protrusions were provided, and they had a height of 0.9 mm, and a pitch of 3.56 mm A ratio of a sum of lateral dimensions of the end surfaces of the protrusions to the lateral dimension of the belt was about 70%.

The cords were made of polyester fiber. Each of the cords had a diameter of 1.0 mm, and was obtained by final-twisting three strands, each of which was prepared by first-twisting two 1100 dtex yarns. The cords were arranged in the lateral direction of the belt at a pitch of 1.15 mm.

A general V-ribbed belt used as a belt of Comparative Example had a length of 1150 mm, a width of 10.7 mm, and a thickness of 4.3 mm (including the ribs). Three ribs were provided, and they had a height of 2.0 mm, and a pitch of 3.56 mm A ratio of a sum of lateral dimensions of the end surfaces of the ribs to the lateral dimension of the belt was about 40%. Like the cords of Example, the cords were made of polyester fiber. Each of the cords had a diameter of 1.0 mm, and was obtained by final-twisting three stands, each of which was prepared by first-twisting two 1100 dtex yarns. The cords were arranged in the lateral direction of the belt at a pitch of 1.15 mm.

Table 1 shows the specifications of the belts of Example and Comparative Example, and the specifications of pulleys used for the tests described below. Table 2 shows the compositions of the rubber layers of the belts.

TABLE 1

| | | | Comparative | |
|---|---|---|---|---|
| | | | Example | |
| | | | (V-ribbed belt) | Example |
| Belt | Dimension | Width | 10.7 | 10.7 |
| | | Total thickness | 4.3 | 3.2 |
| | | Length | 1150 | 1120 |
| | | Number of anti-snaking grooves | — | 3 raised |
| | | | | portions |
| | | | | (2 grooves) |
| | | Number of ribs | 3 | — |
| | Transmission | Surface shape | V-ribbed | flat |
| | surface | | | |
| | Example: anti- | Groove pitch | 3.56 | 3.56 |
| | snaking groove | Groove depth | 2 | 0.9 |
| | Comparative | Arc of groove bottom rb | 0.15 | 0.15 |
| | Example: ribbed | Angle of side surface of groove | 40 | 40 |
| | | Width of flat portion at distal end of | 1.5 | 2.4 |
| | | raised portion | | |
| | | Arc of distal end of raised portion | 0.6 | None |
| | | Ratio of flat surface area to total belt | 40% | 70% |
| | | area | | |
| | Structure | Cord diameter | 1 | 1 |
| | | Cord pitch | 1.15 | 1.15 |
| | Material of | Inner rubber layer (transmission | Composition A | Composition C |
| | rubber layer | surface/ribbed surface) | | |
| | | Rubber layer with | Composition B | Composition B |
| | | embedded cords | | |
| | | Outer rubber layer | Composition A | Composition A |
| | | (anti-snaking, back surface) | | |
| | Cord | Material | Polyester | Polyester |
| | | Structure | 1100 dtex/2 × 3 | 1100 dtex/2 × 3 |
| | | Treatment | RFL | RFL |
| Pulley | Shape | Drive/driven pulleys | V-ribbed | Flat |
| | | Pulley on which back surface of belt is | Flat | Provided with |
| | | wrapped | | longitudinal |
| | | | | grooves |
| | Shape of anti- | Groove pitch | — | 3.56 |
| | snaking groove | Groove depth | — | 0.85 |
| | | Arc of end of protrusion between | — | 0.3 |
| | | grooves Rt | | |
| | | Angle of side surface of groove | — | 40 |
| | | Width of flat part of groove bottom | — | 2.3 |
| | | Arc of groove bottom | — | 0.1 or smaller |
| | Shape of rib | Rib pitch | 3.56 | — |
| | | Depth of groove between ribs | 3.16 | — |
| | | Arc of end of rib | 0.3 | — |
| | | Arc of bottom between ribs | 0.25 | — |
| | | Angle of rib | 40 | — |
| | Drive/driven | Material | S45C | S45C |
| | pulleys | | | |
| | Pulley on which | Material | S45C | S45C |
| | back surface of | | | |
| | belt is wrapped | | | |

TABLE 2

| | PHP | | | |
|---|---|---|---|---|
| Manufacturer | (trade name) | Composition A | Composition B | Composition C |
| JSR | JSR EP22 | 100 | | 100 |
| JSR | JSR EP33 | | 100 | |
| Tokai Carbon | SEAST SO | 60 | 50 | 75 |
| Nippon Silica | Nipseal VN3 | | 20 | |
| Japan Sun Oil | Sunpar 2280 | 5 | 10 | 5 |
| Sakai Chemical | Zinc oxide | 5 | 5 | 5 |
| Industry | type III | | | |
| NOF Corporation | Stearic acid | 1 | 1 | 1 |
| Ouchi Shinko | NOCRAC 224 | 0.5 | 2 | 0.5 |
| Chemical Industrial | | | | |
| Ouchi Shinko | NOCRAC MB | 2 | 1 | 2 |
| Chemical Industrial | | | | |
| Nippon Kanryu | Seimi oil | 2.5 | 3.18 | 2.5 |
| Industry | sulfur | | | |
| Sanshin Chemical | Sanceler TT | 0.5 | 0.5 | 0.5 |
| Industry | | | | |
| Ouchi Shinko | Nocceler CZ | 1 | 0.5 | 1 |
| Chemical Industrial | | | | |
| Ouchi Shinko | Nocceler DM | | 0.5 | |
| Chemical Industrial | | | | |
| Ouchi Shinko | Nocceler EZ | 1 | 1 | 1 |
| Chemical Industrial | | | | |
| Asahi Kasei | Leona 66 | 20 | | |
| Corporation | (2 mm cut) | | | |

### —Test for Evaluating Transmission Capability etc.—

According to a general test method, transmission capability, transmission efficiency, and heat generation of the belts of Example and Comparative Example were checked. FIG. 4 shows a layout of pulleys of a belt running tester. A drive pulley 41 and a driven pulley 42 of 68 mm in diameter, and a fixed idler pulley 43 of 70 mm in diameter were used. The belt B was routed between the drive pulley 41 and the driven pulley 42, and the fixed idler pulley 43 was pressed onto an outer surface of looser one of straight parts of the belt between the pulleys 41 and 42. The driven pulley 42 had a movable rotation axis, and was able to apply deadweight DW on the belt B.

In Example, the drive pulley 41 and the driven pulley 42 around which the substantially flat inner surface of the belt B was wrapped were flat pulleys, and the idler pulley 43 around which the outer surface of the belt provided with the protrusions was wrapped was a restriction pulley (in this case, a general ribbed pulley was used as the restriction pulley). In contrast, the drive pulley 41 and the driven pulley 42 around which the V-ribbed belt of Comparative Example was wrapped were ribbed pulleys, and the idler pulley 43 was a flat pulley. The same was applied to the following tests.

Two types of DW (588 N≈60 kgf, 883 N≈90 kgf) were applied to the driven pulley 42 in a direction in which belt tension increases (to the right in FIG. 4) in a normal temperature atmosphere, and the drive pulley 41 was rotated at 3600 rpm to measure a change in slip ratio according to increase in rotational load of the driven pulley 42. The transmission capability of the belt B was represented by a relationship between an axial load and a load torque relative to the obtained slip ratio of the belt.

Specifically, as indicated by a graph of FIG. 5, the higher the load torque was when the slip ratio reached an acceptable limit (2% in general), the higher the belt transmission capability was. In the illustrated example, when the slip ratio was 2%, the belt of Example showed a torque of 19 N (DW: 588 N, a graph of a solid line with symbol o), and a torque of 27 Nm (DW: 883 N, a graph of a broken line with symbol o). The belt of Comparative Example showed a torque of 11 N (DW: 588 N. a graph of a solid line with symbol Δ), and a torque of 12 Nm (DW: 883 N, a graph of a broken line with symbol Δ). The belt transmission system of the present invention showed the transmission capability twice as high as the transmission capability of the system using the V-ribbed belt, although the belt transmission system of the present invention did not provide the wedge effect.

This is presumably because the transmission surface of the belt and the cords in the belt are close to each other, and a slip ratio due to elastic slip is reduced, thereby causing stick-slip only when the torque is high. It has been known that the shear deformation of the rubber layer affects the transmission capability of the belt. However, it has not been known that the shear deformation has such a significant adverse effect. This can be considered as an epoch-making finding.

In general, short fiber is mixed in the ribbed rubber layer of the V-ribbed belt to reduce a friction coefficient of the belt surface, thereby preventing the occurrence of noise caused by the belt coming onto and separating from the ribbed pulley. The same is applied to the belt of Comparative Example. In the belt of Example, the short fiber was not mixed in the inner rubber layer which constitutes the transmission surface, and the friction coefficient was higher than that of Comparative Example. The test results were presumably derived from the difference in friction coefficient.

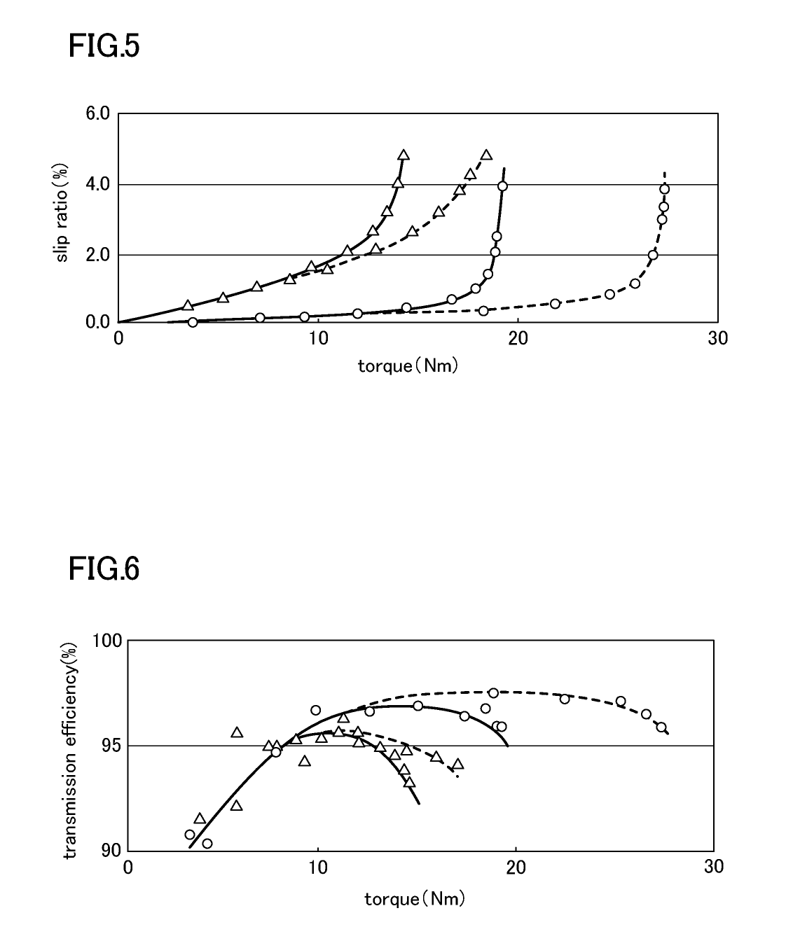

In the above-described test, the number of revolutions and the torque of the drive pulley 41 and the driven pulley 42 were measured to calculate transmission efficiency corresponding to the load torque. A graph of FIG. 6 shows the results. Referring to the graph of FIG. 6 together with the graph of FIG. 5, the belt of Comparative Example had a maximum efficiency of 95-96% in a practical range (in a range where the slip ratio is 2% or lower), while the belt of Example had a maximum efficiency of 97-98%. This indicates that the efficiency of the belt transmission system of the present invention is higher by as much as 2% than that of the system using the V-ribbed belt which has generally been regarded as having high efficiency. This is presumably because all the losses induced by bending, friction between the belt and the pulley, and shear deformation of the ribbed rubber layer were reduced.

The above-described belt running tester was used to check the heat generation of the belt. Specifically, an initial belt temperature was set to 30° C., and the belt was allowed to run for break-in for 30 minutes under a DW of 588 N, and no load. Then, the temperature of the belt of Example was increased to 47° C., and the temperature of the belt of Comparative Example was increased to 43° C. Then, the transmission capability was measured by applying DW of 588 N, and 883 N until the slip ratio reached 5%. The temperature of the belt of Example was increased to 73° C., and the temperature of the belt of Comparative Example was increased to 94° C.

Specifically, although a large rotational load was applied to the belt of Example having higher transmission capability, the temperature increase of the belt was smaller than that of the belt of Comparative Example by as much as 21° C. This indicates that the heat generation is sufficiently reduced by the reduction of the losses induced by bending, friction, and shear deformation. This presumably has a great effect on the durability of the belt.

### —Durability Test—

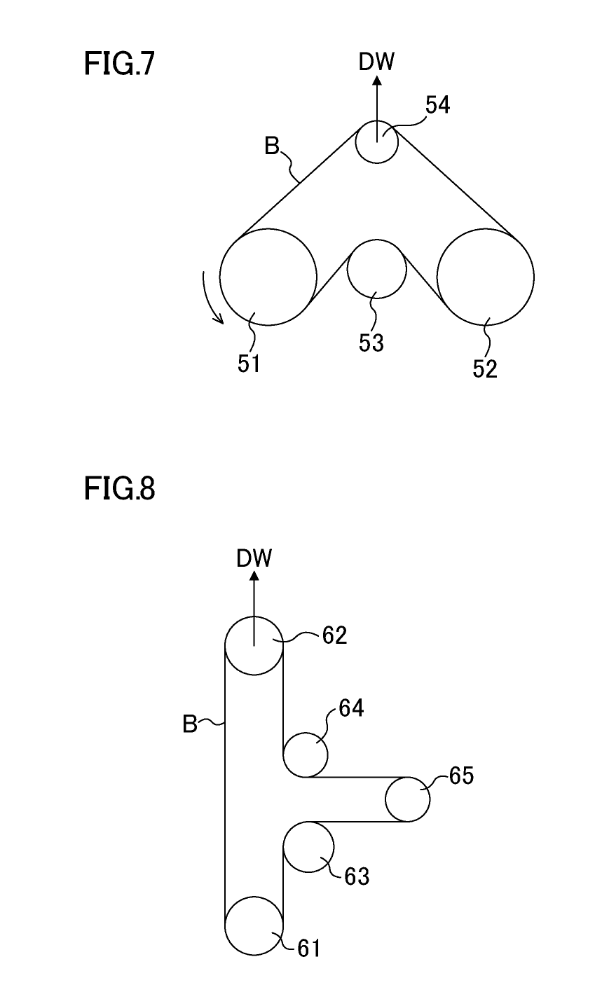

Then, a durability test for resistance to heat, resistance to bending, and resistance to high tension was performed. FIG. 7 shows a layout of pulleys for the heat resistance durability test. In this test, a drive pulley 51 and a driven pulley 52 of 120 mm in diameter, a fixed idler pulley 53 of 70 mm in diameter, and a movable idler pulley 54 of 55 mm in diameter having a movable rotation axis were used. The belt was routed between the drive pulley 51 and the driven pulley 52. One of straight parts of the belt between the pulleys 51 and 52 was wrapped around the fixed idler pulley 53, and the other straight part was wrapped around the movable idler pulley 54. The belt B was wrapped around the idler pulleys 53 and 54 to form a wrap angle of 90 degrees.

In an atmosphere at 85±3° C., the drive pulley 51 was rotated at a rotation speed of 4900 rpm to rotate the driven pulley 52 by a drive power of 11.768 kW (≈16 PS), and a load DW (559 N≈57 kgf) was applied to the movable idler pulley 54 in a direction in which belt tension increases (upward in FIG. 7). In this state, endurance time of each belt was measured. As a result, the V-ribbed belt of Comparative Example generated a crack in the V-ribbed surface after 554 hours, while the belt of Example did not generated any crack even after 2000 hours.

FIG. 8 shows a layout of pulleys of a multi-axis bending tester used to evaluate the degree of fatigue of the belt. The tester includes a drive pulley 61 and a driven pulley 62 of 60 mm in diameter arranged to separate from each other in the vertical direction (the upper one is the driven pulley, and the lower one is the drive pulley), a pair of idler pulleys 63 and 64 of 50 mm in diameter arranged substantially in the middle of the pulleys 61 and 62 in the vertical direction, and an idler pulley 65 of 60 mm in diameter arranged on the right of the pulleys 63 and 64 to separate from the pulleys 63 and 64.

The belt B was wrapped around the drive pulley 61, the driven pulley 62, and the idler pulley 65 with the inner surface of the belt in contact with the pulleys, and was wrapped around the idler pulleys 63 and 64 with the outer surface of the belt in contact with the pulleys to form a wrap angle of 90° C. With the uppermost driven pulley 62 pulled upward to apply a deadweight DW of 392 N (≈40 kgf) in a normal temperature atmosphere, the lowermost drive pulley 61 was rotated at a rotation speed of 5100 rpm. The V-ribbed belt of Comparative Example generated a crack in the V-ribbed surface after 2250 hours. The belt of Example did not generate any crack even after 5000 hours.

Although not shown, the load DW applied to the movable idler pulley under the same test conditions as the heat resistance durability test was set to 981 N≈100 kgf, and endurance time of each belt under high tension was measured. The V-ribbed belt of Comparative Example experienced separation of the cords after 23.5 hours. The belt of Example was not broken even after 500 hours.

Thus, the belt of Example showed the durability of heat resistance more than triple as high as that of the belt of Comparative Example, the durability of resistance to bending more than twice as high as that of the belt of Comparative Example, and the durability of resistance to high tension more than twenty times higher than that of the belt of Comparative Example. This indicates that the cords are less likely to separate from the rubber layer due to the deformation and/or the heat generation of the belt even when a tension or a load per unit width of the belt is increased. Therefore, as described above, the belt can be narrowed as compared with the V-ribbed belt.

### Other Embodiments

The structures of the belt transmission system A and the power transmission belt B are not limited to those of the above-described embodiment, and may include structures except for the described structures. Specifically, in the above embodiment, the tension pulley 5 and the idler pulley 6 having no rotational load are used as the restriction pulleys for restricting the snaking of the belt B. However, a driven pulley to which a relatively small load is applied, such as a water pump pulley, may be used as the restriction pulley.

In the above-described embodiment, the end surfaces of the protrusions 82a formed on the outer rubber layer 82 of the power transmission belt B are flat surfaces to be in contact with the bottoms of the circumferential grooves 5a of the pulley 5, and the area of the end surfaces occupy half or more of the whole area of the belt B. However, the end surfaces may not be flat, and the determined ratio of the area is merely one of preferable examples.

In addition to, or instead of allowing the end surfaces of the protrusions 82a to be in contact with the bottoms of the circumferential grooves 5a of the pulley 5, an outer circumferential portion of the restriction pulley 5, 6 except for the circumferential grooves 5a may be brought into contact with the bottom of the valley between the adjacent protrusions 82a.

The material of the drive B indicated in the above-described embodiment is merely an example, and the present invention is not limited thereto. Instead of providing the adhesive rubber layer 80, the belt B may include the cords 9 embedded in the inner rubber layer 81 or the outer rubber layer 82. When the cords are made of aramid fiber, the slipping and the heat generation of the belt B are reduced, thereby improving the advantages of the present invention.

### INDUSTRIAL APPLICABILITY

As described above, the belt transmission system of the present invention can improve the transmission efficiency and the durability of the belt comparable to those of the system using the flat belt, and can keep the belt running stably even when rainwater etc. is adhered to the belt or the pulley. Therefore, the belt transmission system of the present invention is particularly suitable for accessory drives of engines of automobiles.

### DESCRIPTION OF REFERENCE CHARACTERS

A Belt transmission system
1 Crank pulley (drive pulley)
2-4 Accessory pulley (driven pulley)
5 Tension pulley (restriction pulley)
5a Circumferential groove
6 Idler pulley (restriction pulley)
B Power transmission belt
b1 Transmission surface
82a Protrusion
9 Cord

1. A belt transmission system comprising:
an endless power transmission belt which is wrapped around a drive pulley, and at least one driven pulley, wherein
the power transmission belt includes
cords which are embedded in the power transmission belt to extend in a longitudinal direction of the belt, and to be aligned in a lateral direction of the belt,
an inner surface inside the cords constituting a substantially flat transmission surface,
a plurality of protrusions which are formed on an outer surface of the power transmission belt to extend in the longitudinal direction of the belt, and to be aligned in the lateral direction of the belt,
the power transmission belt is wrapped around the drive pulley, and the at least one driven pulley with the inner surface in contact with the pulleys, and
a restriction pulley having a plurality of circumferential grooves formed in an outer circumferential surface thereof is pressed onto the outer surface of the power transmission belt to engage with the protrusions, thereby restricting movement of the power transmission belt in the lateral direction of the belt.

2. The belt transmission system of claim 1, wherein
the restriction pulley is used as an idler pulley, or a driven pulley to which a relatively small load is applied.

3. The belt transmission system of claim 1, wherein
each of the protrusions of the power transmission belt has a trapezoidal cross section in which side surfaces of the protrusion inclined to approach each other toward a distal end thereof, and
each of the circumferential grooves of the restriction pulley in which the corresponding protrusion enters has side surfaces which are inclined to move away from each other from a bottom to an opening end thereof.

4. The belt transmission system of claim 3, wherein
an end surface at the distal end of each of the protrusions of the power transmission belt is in contact with a bottom surface of the circumferential groove of the restriction pulley in which the protrusion enters.

5. The belt transmission system of claim 4, wherein
a sum of dimensions of the end surfaces of the protrusions in the lateral direction of the belt is half or more of a dimension of the power transmission belt in the lateral direction of the belt.

6. The belt transmission system of claim 4, wherein
the outer circumferential surface of the restriction pulley except for the circumferential grooves is in contact with part of the power transmission belt between adjacent protrusions.

7. A power transmission belt comprising:
an inner surface of an endless belt body constituting a substantially flat transmission surface, the power transmission belt being wrapped around a drive pulley, and at least one driven pulley for power transmission, wherein
cords are embedded in the belt body to extend in a longitudinal direction of the belt, and to be aligned in a lateral direction of the belt, and
a plurality of protrusions are formed on an outer surface of the belt outside the cords to extend in the longitudinal direction of the belt, and to be aligned in the lateral direction of the belt in such a manner that the protrusions engage with a restriction member for restricting movement of the belt in the lateral direction of the belt.

8. The power transmission belt of claim 7, wherein
each of the protrusions has a trapezoidal cross section in which side surfaces of the protrusion are inclined to approach each other toward a distal end thereof.

9. The power transmission belt of claim 8, wherein
a pulley having a plurality of circumferential grooves formed in an outer circumferential surface thereof constitutes the restriction member, and
each of the protrusions has an abutment surface which is provided at the distal end thereof, and is in contact with a bottom surface of the corresponding circumferential groove.

10. The power transmission belt of claim 9, wherein
a pulley having a plurality of circumferential grooves formed in an outer circumferential surface thereof constitutes the restriction member, and
an abutment portion is provided between adjacent protrusions to be in contact with the outer circumferential surface of the pulley except for the circumferential grooves.
